(19) United States
(12) Patent Application Publication
(10) Pub. No.: US 2008/0178207 A1
(43) Pub. Date: Jul. 24, 2008

(54) OPTICAL DISC WITH ENFORCED STRUCTURE

(76) Inventors: JIA-RAY LIU, Taoyuan City (TW); Fung-Hsu Wu, Gueishan Township (TW)

Correspondence Address: HOFFMAN WARNICK LLC, 75 STATE STREET, 14TH FLOOR, ALBANY, NY, 12207, US

(21) Appl. No.: 11/849,387

(22) Filed: Sep. 4, 2007

(30) Foreign Application Priority Data
Jan. 24, 2007 (TW) 096102606

(51) Int. Cl. G11B 7/24

(52) U.S. Cl. 720/718

(57) ABSTRACT

The invention discloses an optical disc comprising a substrate, a multi-layer structure, and a plurality of ribs. The substrate has a first surface and a second surface set opposite to the first surface. The multi-layer structure is formed on the first surface of the substrate and comprises at least one recording layer. The ribs are formed on the second surface of the substrate. The ribs are used for increasing the rigidity of the optical disc, such that a runout of the optical disc can be suppressed while the optical disc is rotated.

### BACKGROUND OF THE INVENTION

1. Field of the Invention

The invention relates to an optical disc and a substrate of the optical disc, and particularly to an optical disc with an enforced structure and a substrate with an enforced structure.

2. Description of the Prior Art

More and more information such as document, photo, music, and movie are recorded and stored in a digital media. Besides, most of the information is also backed up in optical storage media such as CD-R, DVD-R, DVD+R, and the like.

Due to low price and rapidly increasing storage capacity, optical discs have been widely applied to be a medium for storing and backing up digital information. However, optical discs driven by recording apparatuses will cause the runout problem while rotating at various speeds.

For example, when a motor of an optical disc drive rotates at a low speed, the rotation of the motor would be unstable. The shaking of the optical disc drive is due to the unstable rotation of the motor. In general, the motor comprises a rotor, a revolving spindle, and a bearing which supports the revolving spindle in a radial and an axial direction. If having a gap exists between the bearing and the motor, the rotor of the optical disc drive would generate a non-repeating runout.

Since the mechanical strength of the outward part of an optical disc is weaker, a runout of the optical disc caused by a higher rotating speed would make the optical disc to be unstable and increase a displacement between an optical pick-up head and tracks of the optical disc. Therefore, the writing performance on the optical disc might be worse due to a serious runout.

Although many methods had been provided to raise the stability while writing information on the optical disc, most of them are used for suppressing the runout of the motor in the optical disc drive while rotating at a lower speed.

Therefore, in order to enhance the rigidity of the optical disc and thereby suppress a runout while rotating the optical disc, the invention provides an optical disc and a substrate thereof with an enforced structure.

### SUMMARY OF THE INVENTION

An optical disc comprises a substrate, a multi-layer structure, and a plurality of ribs in a preferred embodiment according to the invention. The substrate has a first surface and a second surface set opposite to the first surface. The multi-layer structure is formed on the first surface of the substrate and comprises at least one recording layer. The ribs are formed on the second surface of the substrate. When the optical disc is rotated, the ribs are used for suppressing a runout of the optical disc.

The advantage and spirit of the invention may be understood by the following recitations together with the appended drawings.

### BRIEF DESCRIPTION OF THE APPENDED DRAWINGS

FIG. 1A is a top view of an optical disc in a preferred embodiment according to the invention.

FIG. 1B is a cross section view along S-S line of the optical disc shown in FIG. 1A.

FIG. 1C is a top view of an optical disc in another preferred embodiment according to the invention.

FIG. 2A is a schematic diagram illustrating a deformation of the outward region of an optical disc with an enforced structure pressed by a force.

FIG. 2B is a simulation result of the optical disc pressed by the force shown in FIG. 2A.

FIG. 3A is a top view of a substrate of the optical disc in another preferred embodiment according to the invention.

FIG. 3B is a cross section view along Y-Y line of the substrate shown in FIG. 3A.

### DETAILED DESCRIPTION OF THE INVENTION

A scope of the invention is to provide an optical disc with an enforced structure and a substrate with an enforced structure to suppress a runout when the optical disc is rotated.

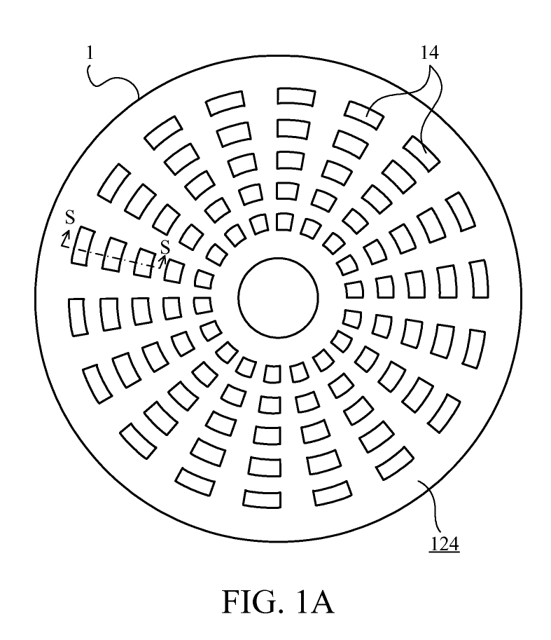

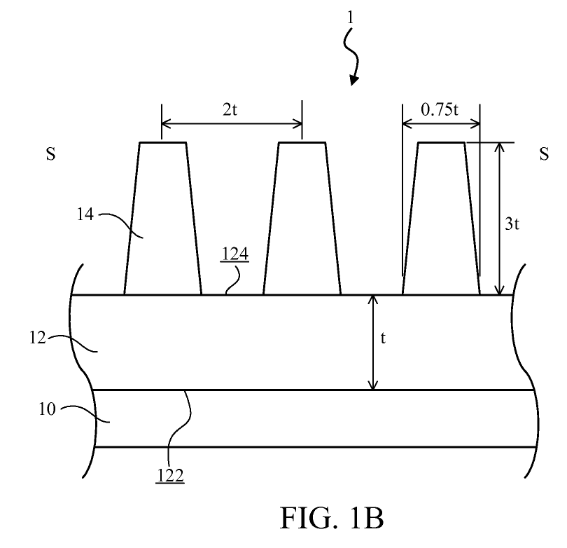

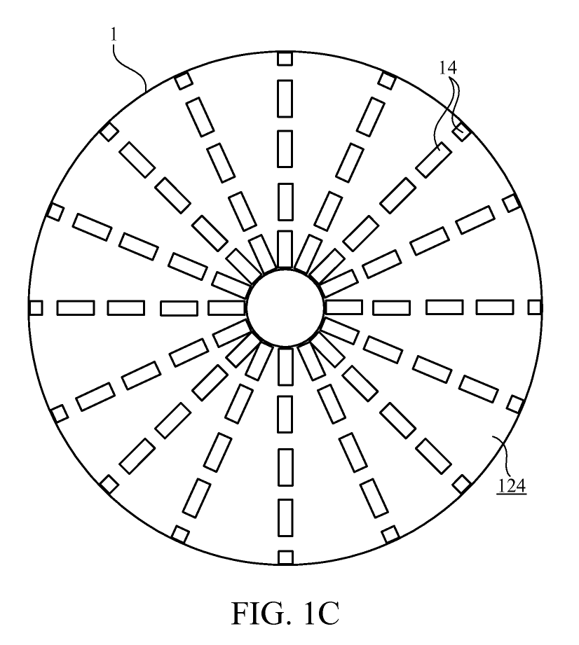

Please refer to FIG. 1A and FIG. 1B. FIG. 1A is a top view of an optical disc 1 in a preferred embodiment according to the invention; FIG. 1B is a cross section view along S-S line of the optical disc 1 shown in FIG. 1A. As shown in FIG. 1B, the optical disc 1 comprises a substrate 12, a multi-layer structure 10, and a plurality of ribs 14.

In this embodiment, the substrate 12 has a first surface 122 and a second surface 124 set opposite to the first surface 122. The multi-layer structure 10 is formed on the first surface 122 of the substrate 12 and comprises at least one recording layer. The ribs 14 are formed on the second surface 124 of the substrate 12. In practical applications, the first surface 122 of the optical disc 1 can be a surface for reflecting a laser emitted from an optical pick-up head.

The ribs 14 formed on the second surface 124 of the substrate 12 provide an enforced structure to enhance the rigidity of the optical disc 1. Accordingly, when the optical disc 1 is rotated at high speeds, the ribs 14 can suppress a runout of the optical disc 1. Therefore, a deviation between a track of the optical disc 1 and an optical pick-up head of an optical disc drive can be miniaturized, such that the time spent to write information on the optical disc 1 is decreased.

A cross section view of ribs 14 is shown in FIG. 1B. In this embodiment, the thickness of a substrate 12 is represented by “t”, a bottom width of each ribs 14 is 0.75*t, the height of each ribs 14 is 3*t, and the central distance between adjacent ribs 14 is 2*t.

Please refer to FIG. 1A and FIG. 1C. FIG. 1C is a top view of an optical disc 1 in another preferred embodiment according to the invention. As shown in FIG. 1A, the ribs 14 formed on the second surface 124 of the substrate are arranged into a form of a concentric circle centered around a rotating center of the optical disc 1. As shown in FIG. 1C, the ribs 14 formed on the second surface 124 of the substrate are arranged into a form of symmetrical radiation centered around a rotating center of the optical disc 1. In another embodiment, the ribs 14 formed on the second surface 124 of the substrate can be arranged into a form of a concentric circle and a symmetrical radiation centered around a rotating center of the optical disc 1. Additionally, the ribs 14 can be formed simultaneously with the substrate 12 by an injection molding or formed by a molding after an injection molding of the substrate 12.

The deformation of the optical disc generated by forces can be discussed according to a finite element simulation analysis. The simulation analysis comprises setting a boundary condition, proceeding with a strain analysis, and analyzing the results, wherein the boundary condition is set according to the physical characters of a material and operation parameters.

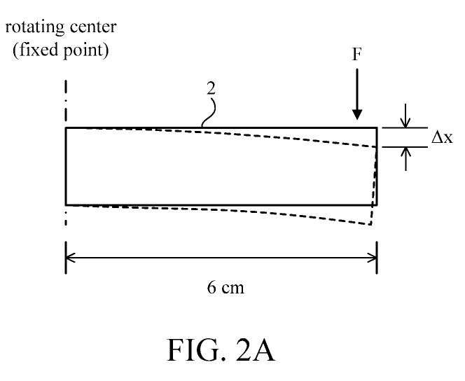

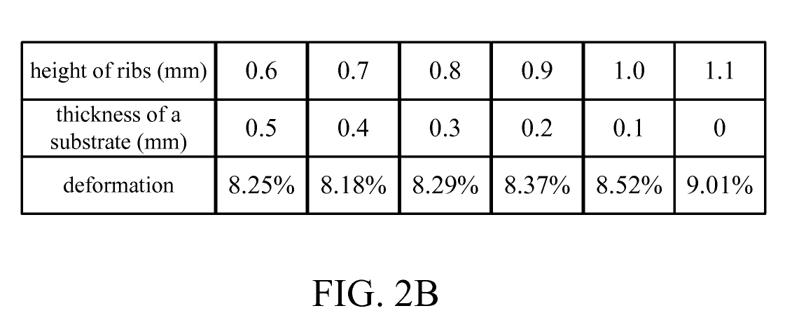

Please refer to FIG. 2A and FIG. 2B. FIG. 2A is a schematic diagram illustrating a deformation Δx of the outward region of an optical disc 2 with an enforced structure applied by a force F. FIG. 2B shows a simulation result of the optical disc 2 applied by the force F shown in FIG. 2A. In the embodiment, a rotating center of the optical disc 2 is regarded as a fixed point. An inward region of the optical disc 2 is fixed on the fixed point. When an applied force F presses on the outward region of the optical disc 2, the deformation Δx of the outward region of the optical disc 2 is the maximum.

In this example, the distance between the fixed point and the outward edge of the optical disc 2 is 6 cm, and the applied force F can be set as 0.01 N. The deformation of the optical disc 2 pressed by the applied force F can be simulated with different heights of the ribs and thicknesses of the substrate. It should be noticed that most optical disc specifications limit the total thickness of the optical disc. Therefore, the thickness of the substrate must be decreased if the height of the ribs is increased. In the embodiment, the sum of the height of the ribs and the thickness of the substrate is limited at 1.1 mm. As shown in FIG. 2B, when the height of the ribs is 0.7 mm, and the thickness of the substrate is 0.4 mm, the deformation of the optical disc 2 is a minimum (8.18%).

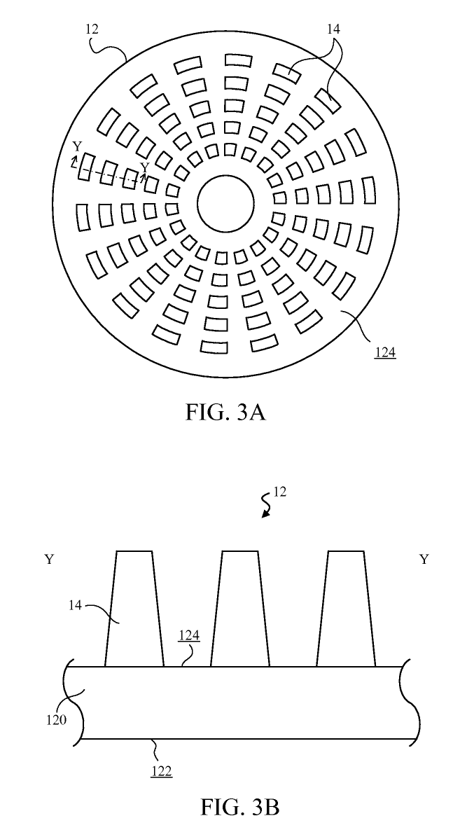

Please refer to FIG. 3A and FIG. 3B. FIG. 3A is a top view of a substrate 12 of the optical disc 1 in another preferred embodiment according to the invention. FIG. 3B is a cross section view along Y-Y line of the substrate 12 shown in FIG. 3A. As shown in FIG. 3B, the substrate 12 comprises a main body 120 and a plurality of ribs 14. The main body 120 has a first surface 122 and a second surface 124 set opposite to the first surface 122. The ribs 14 are formed on the second surface 124 of the main body 120. A multi-layer structure including at least one recording layer can be further formed on the first surface 122 of the main body 120. The arrangement, formation, and structure of the ribs 14 have been described in the aforesaid paragraphs, thus these are not described again herein.

Additionally, the structure of an optical disc according to the invention can conform to one of the specifications consisting of a DVD+R specification, a DVD-R specification, a HD-DVD-R specification, a BD-R specification, a DVD+RW specification, a DVD-RW specification, a DVD-RAM specification, a HD-DVD-RW specification, a BD-RE specification, or a specification of the other optical discs with a dummy substrate.

Compared with prior arts, when the optical disc of the invention is rotated at a high speed, a runout of the optical disc can be suppressed. Meanwhile, a deviation between a track of the optical disc and an optical pick-up head of an optical disc drive can be miniaturized, such that the time spend to write the information into the optical disc is decreased.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An optical disc, comprising:
a substrate having a first surface and a second surface set opposite to the first surface;
a multi-layer structure, formed on the first surface of the substrate, comprising at least one recording layer; and
a plurality of ribs, formed on the second surface of the substrate, for suppressing a runout of the optical disc while the optical disc is rotated.

2. The optical disc of claim 1, wherein the ribs formed on the second surface of the substrate are arranged into a form of a concentric circle centered around a rotating center of the optical disc.

3. The optical disc of claim 1, wherein the ribs formed on the second surface of the substrate are arranged into a form of a symmetrical radiation centered around a rotating center of the optical disc.

4. The optical disc of claim 1, wherein the ribs formed on the second surface of the substrate are arranged into a form of a concentric circle and a symmetrical radiation centered around a rotating center of the optical disc.

5. The optical disc of claim 1, wherein a structure of the optical disc conforms to one of the specifications consisting of a DVD+R specification, a DVD-R specification, a HD-DVD-R specification, a BD-R specification, a DVD+RW specification, a DVD-RW specification, a DVD-RAM specification, a HD-DVD-RW specification, and a BD-RE specification.

6. A substrate of an optical disc, comprising:
a main body having a first surface and a second surface set opposite to the first surface; and
a plurality of ribs, formed on the second surface of the main body, for suppressing a runout of the optical disc while the optical disc is rotated.

7. The substrate of claim 6, wherein a multi-layer structure of the optical disc is formed on the first surface of the main body, and the multi-layer structure comprises at least one recording layer.

8. The substrate of claim 6, wherein the ribs formed on the second surface of the substrate are arranged into a form of a concentric circle centered around a rotating center of the main body.

9. The substrate of claim 6, wherein the ribs formed on the second surface of the substrate are arranged into a form of a symmetrical radiation centered around a rotating center of the main body.

10. The substrate of claim 6, wherein the ribs formed on the second surface of the substrate are arranged into a form of a concentric circle and a symmetrical radiation centered around a rotating center of the main body.

11. The substrate of claim 6, wherein a structure of the optical disc conforms to one of the specifications consisting of a DVD+R specification, a DVD-R specification, an HD-DVD-R specification, a BD-R specification, a DVD+RW specification, a DVD-RW specification, a DVD-RAM specification, an HD-DVD-RW specification, and a BD-RE specification.

12. An optical disc with an enforced structure, the optical disc comprising a substrate, the substrate having a first surface, a second surface, and a plurality of ribs formed on the second surface, the second surface being opposite to the first surface, the ribs being used as the enforced structure and to suppress a runout of the optical disc while the optical disc is rotated.

13. The optical disc of claim 12, further comprising:
a multi-layer structure, formed on the first surface of the substrate, comprising at least one recording layer.

14. The optical disc of claim 12, wherein the ribs formed on the second surface of the substrate are arranged into a form of a concentric circle centered around a rotating center of the optical disc.

15. The optical disc of claim 12, wherein the ribs formed on the second surface of the substrate are arranged into a form of a symmetrical radiation centered around a rotating center of the optical disc.

16. The optical disc of claim 12, wherein the ribs formed on the second surface of the substrate are arranged into a form of a concentric circle and a symmetrical radiation centered around a rotating center of the optical disc.

17. The optical disc of claim 12, wherein a structure of the optical disc conforms to one of the specifications consisting of a DVD+R specification, a DVD-R specification, an HD-DVD-R specification, a BD-R specification, a DVD+RW specification, a DVD-RW specification, a DVD-RAM specification, an HD-DVD-RW specification, and a BD-RE specification.
